(19) United States
(12) Patent Application Publication
(10) Pub. No.: US 2026/0023341 A1
(43) Pub. Date: Jan. 22, 2026

(54) IMAGE FORMATION SYSTEM

(71) Applicant: FUJIFILM BUSINESS INNOVATION CORP., Tokyo (JP)

(72) Inventor: Yosuke KASUYA, Kanagawa (JP)

(73) Assignee: FUJIFILM BUSINESS INNOVATION CORP., Tokyo (JP)

(21) Appl. No.: 19/051,698

(22) Filed: Feb. 12, 2025

(30) Foreign Application Priority Data
Jul. 19, 2024 (JP) 2024-116273

(51) Int. Cl. G03G 15/00; G03G 15/043

(52) U.S. Cl. CPC G03G 15/5045; G03G 15/0435; G03G 2215/00084

(57) ABSTRACT

An image formation system includes an image carrier that rotates; an opposed member that is opposed to the image carrier and is connected to the image carrier by an adjuster that adjusts a distance to the image carrier; and a temperature detector that is provided on any two or more components among the opposed member, the adjuster, and components other than the adjustor that are interposed between the opposed member and the image carrier.

### CROSS-REFERENCE TO RELATED APPLICATIONS

This application is based on and claims priority under 35 USC 119 from Japanese Patent Application No. 2024-116273 filed Jul. 19, 2024.

### BACKGROUND

### (i) Technical Field

The present disclosure relates to an image formation system.

### (ii) Related Art

Japanese Unexamined Patent Application Publication No. 2014-74837 discloses an image recording device that records an image on a recording medium by radiating light, and the image recording device includes a holding unit, an optical unit, a movement mechanism, a temperature detection unit, and a controller. The holding unit holds the recording medium. The optical unit irradiates the recording medium held by the holding unit with light, and a focal position of the emitted light is variable. The movement mechanism moves, in a scanning direction, an irradiation position on the recording medium that is irradiated with the light from the optical unit by moving the optical unit relative to the holding unit. The temperature detection unit detects a temperature of the optical unit or surroundings thereof. The controller acquires a shift amount of the focal position with respect to thermal expansion of the optical unit on the basis of the temperature detected by the temperature detection unit and corrects the focal position.

Japanese Unexamined Patent Application Publication No. 2006-187929 discloses an image forming apparatus that includes a photoreceptor, an LED head, a displacement sensor, a filter, a driving unit, and a position controller. The photoreceptor has a drum shape having a photosensitive part on a circumferential surface thereof. The LED head includes plural LEDs that are modulated in accordance with an image signal and expose the photosensitive part of the rotating photoreceptor to light, and the plural LEDs are arranged along a rotary axis direction of the photoreceptor. The displacement sensor detects displacement of the circumferential surface of the photoreceptor. The filter extracts a frequency component that includes a rotation frequency component of the photoreceptor and is approximately 10 times or less higher than the rotation frequency component from a detection signal of the displacement sensor and regards the frequency component as displacement information of the circumferential surface of the photoreceptor. The driving unit advances and retreats the LED head with respect to the circumferential surface of the photoreceptor. The position controller performs control of keeping a distance between the LED head and the circumferential surface of the photoreceptor by driving the driving unit in accordance with the displacement information acquired by the filter.

Japanese Unexamined Patent Application Publication No. 2005-250105 discloses an image forming apparatus in which a sheet-shaped recording medium is wound around an outer surface of a drum, light is emitted from a recording head that is opposed to the drum while rotating the drum, and the recording medium on the drum is exposed to the light. The image forming apparatus includes an autofocus mechanism and an error determination unit. The autofocus mechanism is a mechanism for measuring a distance from the recording head to the drum by a distance measurement function and keeping a focal position to a proper one during exposure. Furthermore, a distance between a recording surface of the recording medium wound around the drum and the recording head is measured by the distance measurement function of the autofocus mechanism before exposure, and in a case where the measured distance is not within a predetermined range, the error determination unit determines this as an error.

### SUMMARY

Aspects of non-limiting embodiments of the present disclosure relate to an image formation system that may keep an increase in cost small as compared with a case where a distance sensor that measures a distance between an image carrier and an opposed member is attached to the opposed member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image formation system including: an image carrier that rotates; an opposed member that is opposed to the image carrier and is connected to the image carrier by an adjuster that adjusts a distance to the image carrier; and a temperature detector that is provided on any two or more components among the opposed member, the adjuster, and components other than the adjustor that are interposed between the opposed member and the image carrier.

### BRIEF DESCRIPTION OF THE DRAWINGS

Exemplary embodiments of the present disclosure will be described in detail based on the following figures, wherein:

FIG. 1 is a schematic view illustrating a configuration of an image formation system according to a first exemplary embodiment viewed from a front side;

FIG. 2 is a schematic configuration diagram illustrating a toner image forming unit of the image formation system according to the first exemplary embodiment;

FIG. 3 illustrates an example of plural temperature sensors provided at one end portion side of a photoconductor drum in an axial direction in the image formation system according to the first exemplary embodiment;

FIG. 4 is a side view illustrating a configuration of an adjusting device that adjusts a distance between an exposure device and the photoconductor drum of the image formation system according to the first exemplary embodiment;

FIG. 5 is a perspective view illustrating an example of a temperature sensor;

FIG. 6 is a block diagram illustrating a hardware configuration of the image formation system according to the first exemplary embodiment;

FIG. 7 is a configuration diagram illustrating an example of temperature sensors provided close to an adjusting device that adjusts a distance between an exposure device and a photoconductor drum of an image formation system according to a second exemplary embodiment;

FIG. 8 is a schematic configuration diagram illustrating a distance sensor that measures a distance between an exposure device and a photoconductor drum and an adjusting device of an image formation system of a comparative example; and

FIG. 9 is a diagram comparing a size of a distance sensor and a size of a temperature sensor.

### DETAILED DESCRIPTION

Exemplary embodiments of the present disclosure are described below with reference to the drawings. In the following description, it is assumed that a direction indicated by arrow W in the drawings is a device width direction and a direction indicated by arrow H is a device height direction. It is also assumed that a direction (a direction indicated by arrow D) orthogonal to the device width direction and the device height direction is a device depth direction.

### First Exemplary Embodiment

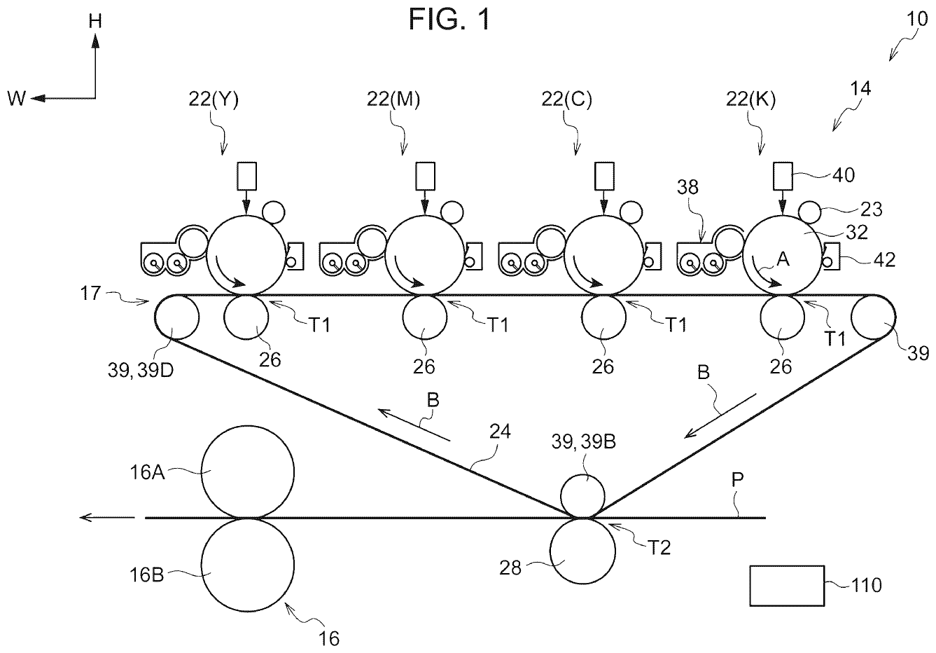

FIG. 1 illustrates an image formation system 10 according to a first exemplary embodiment. First, an overall configuration of the image formation system 10 (see FIG. 1) of the first exemplary embodiment is described. Next, a substantial part of the image formation system 10 is described.

### Overall Configuration of Image Formation System 10

As illustrated in FIG. 1, the image formation system 10 is an example of an image formation system that forms an image on a recording medium P. Specifically, the image formation system 10 is an electrophotographic image formation system that forms a toner image on the recording medium P. More specifically, the image formation system 10 includes an image forming unit 14 and a fixing device 16. The image forming unit 14 has a function of forming toner images of different colors on the recording medium P. Specifically, the image forming unit 14 includes a toner image forming unit 22 and a transfer device 17. Furthermore, the image formation system 10 includes a control device 110 that controls each unit.

### Toner Image Forming Unit 22

As illustrated in FIG. 1, plural toner image forming units 22 are provided to form toner images of respective colors. In the first exemplary embodiment, toner image forming units 22 of four colors, specifically, yellow (Y), magenta (M), cyan (C), and black (K) are provided. (Y), (M), (C), and (K) illustrated in FIG. 1 indicate constituent parts corresponding to the above colors.

Since the toner image forming units 22 of the respective colors have similar configurations except for toner used, reference signs are given to units of the toner image forming unit 22 (K) in FIG. 1 representing the toner image forming units 22 of the respective colors.

The toner image forming units 22 of the respective colors each include a photoconductor drum 32 that rotates in one direction (for example, a direction indicated by arrow A, which is a counterclockwise direction, in FIG. 1). The photoconductor drum 32 is an example of an image carrier. Furthermore, the toner image forming units 22 of the respective colors each include a charger 23, an exposure device 40, a developing device 38, and a cleaning device 42. The exposure device 40 is an example of an opposed member and an example of an exposure unit.

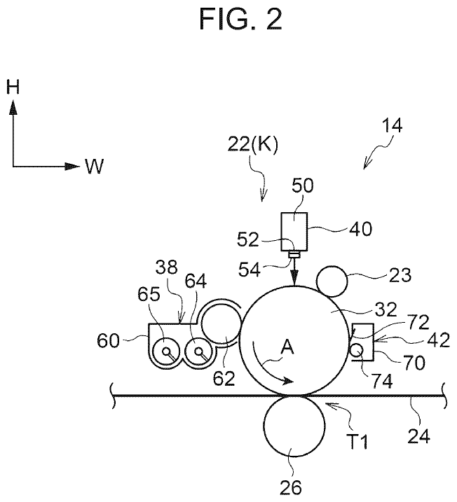

FIG. 2 illustrates the toner image forming unit 22. Since the toner image forming units 22 have similar configurations other than a color of toner, the reference signs Y, M, C, and K of the colors are omitted in FIG. 2.

As illustrated in FIG. 2, the charger 23 is a charging roller that rotates in contact with the photoconductor drum 32. Note that a configuration of the charger 23 is changeable.

The exposure device 40 is disposed on a downstream side relative to the charger 23 in the rotation direction of the photoconductor drum 32 so as to be opposed to the photoconductor drum 32. The exposure device 40 is disposed away from the photoconductor drum 32.

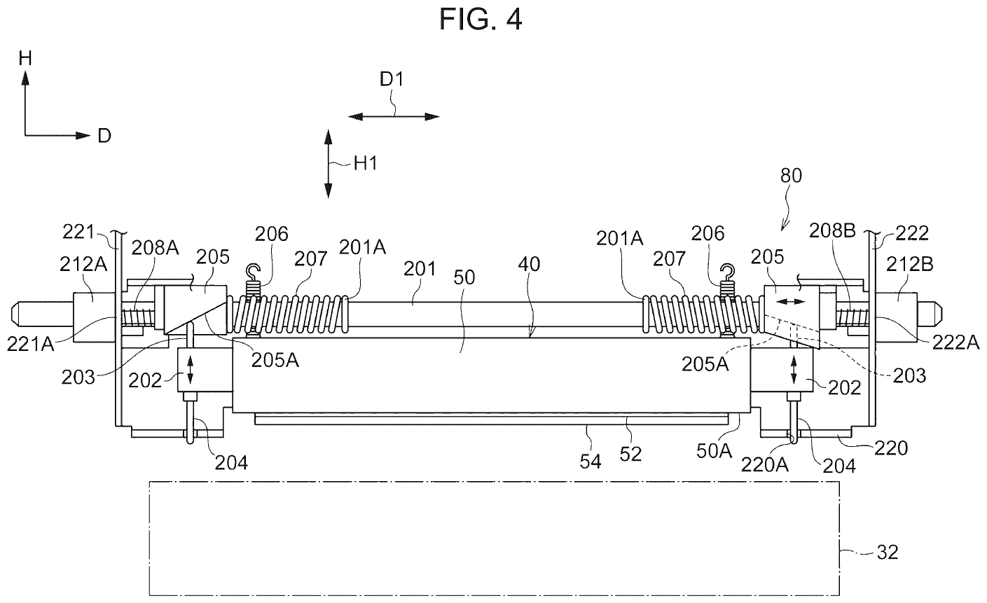

The exposure device 40 includes a housing 50 having a rectangular shape. The exposure device 40 includes, on a surface 50A of the housing 50 that faces the photoconductor drum 32, a lens group 54 including plural lenses arranged in an axial direction of the photoconductor drum 32 and a substrate 52 on which plural light-emitting elements that emit light are mounted (see FIG. 4). In the exposure device 40, light emitted from the plural light-emitting elements passes through the plural lenses, so that the photoconductor drum 32 is exposed to the light. This forms an electrostatic latent image on a surface of the photoconductor drum 32. For example, the exposure device 40 is an LED print head including LEDs, which are an example of light-emitting elements.

The developing device 38 is disposed on a downstream side relative to the exposure device 40 in the rotation direction of the photoconductor drum 32 so as to be opposed to the photoconductor drum 32. The developing device 38 includes a housing 60, a development roller 62, and plural (for example, two) augers 64 and 65. The housing 60 stores therein a developer containing toner. The development roller 62 holds the developer and transports the developer to the photoconductor drum 32. The augers 64 and 65 transport the developer in a direction opposite to an axial direction while stirring the developer. The developer stirred by the auger 65 is supplied to the development roller 62.

The cleaning device 42 is disposed on a downstream side relative to a first transfer position T1 (see FIG. 1) in the rotation direction of the photoconductor drum 32 and is disposed on an upstream side relative to the charger 23. For example, the cleaning device 42 includes, in a housing 70, a cleaning blade 72 and a cleaning roller 74. The cleaning blade 72 and the cleaning roller 74 remove toner and the like remaining on a surface of the photoconductor drum 32 by making contact with the surface of the photoconductor drum 32.

As illustrated in FIG. 1, in each of the toner image forming units 22 of the respective colors, the charger 23 charges the surface of the photoconductor drum 32. Furthermore, the exposure device 40 forms an electrostatic latent image on the surface of the photoconductor drum 32 by exposing the photoconductor drum 32 charged by the charger 23 to light. Furthermore, the developing device 38 forms a toner image by developing the electrostatic latent image formed on the surface of the photoconductor drum 32 with toner. The cleaning device 42 removes toner remaining on the surface of the photoconductor drum 32 after transfer of the toner image.

### Transfer Device 17

As illustrated in FIG. 1, the transfer device 17 is a device that transfers toner images formed by the toner image forming units 22 onto the recording medium P. Specifically, the transfer device 17 first-transfers the toner images on the photoconductor drums 32 of the respective colors onto a transfer belt 24 serving as an intermediate transfer body and secondary-transfers the toner images onto the recording medium P. Specifically, as illustrated in FIG. 1, the transfer device 17 includes the transfer belt 24, first transfer rollers 26, and a secondary transfer roller 28.

Each of the first transfer rollers 26 is a roller that transfers the toner image on the photoconductor drum 32 of a corresponding color onto the transfer belt 24 at the first transfer position T1 between the photoconductor drum 32 and the first transfer roller 26. In the first exemplary embodiment, a first transfer electric field is applied between the first transfer roller 26 and the photoconductor drum 32, and thereby the toner image formed on the photoconductor drum 32 is transferred onto the transfer belt 24 at the first transfer position T1.

Toner images are transferred from the photoconductor drums 32 of the respective colors onto an outer circumferential surface of the transfer belt 24. Specifically, the transfer belt 24 is configured as follows. As illustrated in FIG. 1, the transfer belt 24 forms an annular shape, and is wound around plural rollers 39 and thereby a posture thereof is decided.

For example, a drive roller 39D among the plural rollers 39 is driven to rotate by a drive unit (not illustrated), and thereby the transfer belt 24 circles in a direction indicated by arrow B. Note that a roller 39B illustrated in FIG. 1 among the plural rollers 39 is an opposed roller 39B that is opposed to the secondary transfer roller 28.

The secondary transfer roller 28 is a roller that transfers the toner images that have been transferred onto the transfer belt 24 onto the recording medium P at a secondary transfer position T2 between the opposed roller 39B and the secondary transfer roller 28. In the first exemplary embodiment, a secondary transfer electric field is applied between the opposed roller 39B and the secondary transfer roller 28, and thereby the toner images transferred onto the transfer belt 24 are transferred onto the recording medium P at the secondary transfer position T2.

### Fixing Device 16

As illustrated in FIG. 1, the fixing device 16 is a device that fixes, on the recording medium P, the toner images transferred onto the recording medium P by the secondary transfer roller 28. Specifically, as illustrated in FIG. 1, the fixing device 16 includes a heating roller 16A serving as a heating member and a pressing roller 16B serving as a pressing member. In the fixing device 16, the toner images formed on the recording medium P are fixed on the recording medium P by heating and pressing the recording medium P by the heating roller 16A and the pressing roller 16B.

### Operation of Image Formation System 10

Next, operation of the image formation system 10 is described.

Upon start of operation of the image formation system 10, in each of the toner image forming units 22 of the respective colors, the photoconductor drum 32 is charged by the charger 23, the photoconductor drum 32 is exposed to light by the exposure device 40, and thus an electrostatic latent image is formed on the surface of the photoconductor drum 32. Furthermore, the electrostatic latent image on the photoconductor drum 32 is developed as a toner image by the developing device 38. As a result, in each of the toner image forming units 22 of the respective colors, a toner image of a corresponding color is formed on the surface of the photoconductor drum 32.

Next, a voltage (first transfer voltage) is applied from a power source (not illustrated) to the first transfer rollers 26 of the respective colors. The drive roller 39D causes the transfer belt 24 to circle in the direction indicated by the arrow. As a result, toner images of the respective colors are first-transferred onto the transfer belt 24 so as to be superimposed.

Furthermore, the recording medium P is transported to the secondary transfer position T2 in synchronization with a timing at which the toner images of the respective colors held on the circling transfer belt 24 reach a position between the opposed roller 39B and the secondary transfer roller 28. At the secondary transfer position T2, the toner images of the respective colors are secondary-transferred onto the recording medium P by application of a voltage (secondary transfer voltage) from a power source (not illustrated) to the opposed roller 39B. Furthermore, the recording medium P is transported to the fixing device 16. Then, the toner images of the respective colors are fixed on the recording medium P by the fixing device 16, and thus an image is formed on the recording medium P.

### Specific Configuration in Vicinity of Exposure Device 40

Next, a specific configuration in the vicinity of the exposure device 40 of the toner image forming unit 22, which is a substantial part of the image formation system 10, is described.

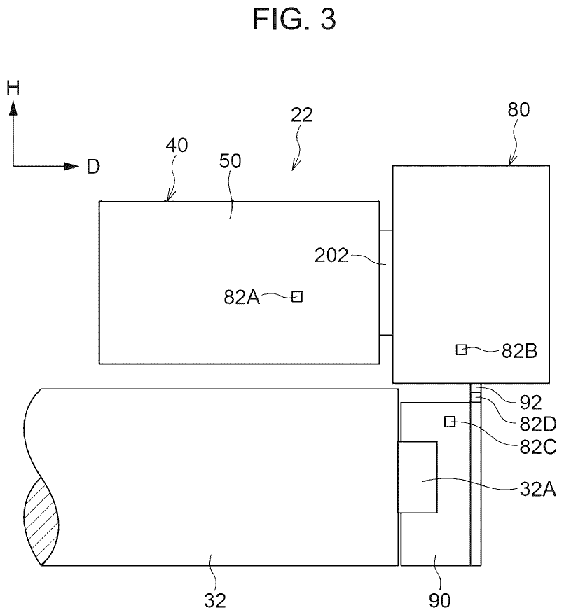

As illustrated in FIG. 3, the image formation system 10 includes an adjusting device 80 that adjusts a distance between the exposure device 40 of the toner image forming unit 22 and the photoconductor drum 32. Furthermore, the image formation system 10 includes plural temperature sensors 82 (e.g., temperature sensors 82A, 82B, 82C, and 82D). The exposure device 40 is connected to the photoconductor drum 32 by the adjusting device 80 that adjusts the distance to the photoconductor drum 32.

### Adjusting Device 80

FIG. 4 is a side view illustrating a configuration of the adjusting device 80. The adjusting device 80 is an example of an adjuster. The adjusting device 80 has the following configuration. As illustrated in FIG. 4, a support unit 202 extends from both end portions of the exposure device 40. A contact pin 203 and a support pin 204 that protrude in a vertical direction (a direction indicated by arrow H1) orthogonal to a longitudinal direction (a direction indicated by arrow D1) of the exposure device 40 are provided on the support unit 202.

An upper end of the contact pin 203 that protrudes upward from the support unit 202 is in contact, from below, with an inclined surface 205A of a mobile body 205 that slidably fits over a part of a support shaft 201. A lower end of the support pin 204 that protrudes downward from the support unit 202 is inserted into a U-shaped long hole 220A formed in a frame 220. One end of a spring 206 is fastened the frame 220, and the exposure device 40 is fastened to the other end of the spring 206 and is biased upward due to elastic force of the spring 206.

The support shaft 201 suspended between a pair of side frame 221 and side frame 222 is positioned above the exposure device 40. A spring 207 is fitted around both end portions of the support shaft 201. One end of the spring 207 is in contact with a flange portion 201A protruding from a circumferential surface of the support shaft 201, and the other end of the spring 207 is in contact with an inner side surface of the mobile body 205 mounted on an outer side of the support shaft 201. The mobile body 205 is thus biased toward an end portion of the support shaft 201 due to elastic force of the spring 207.

The pair of side frame 221 and side frame 222 have screw holes 221A and 222A into which adjustment screws 208A and 208B are screwed, respectively. Leading ends of the adjustment screws 208A and 208B screwed into the screw holes 221A and 222A from outside the side frame 221 and the side frame 222 are in contact with side surfaces of the mobile bodies 205. An end portion of the adjustment screw 208A outside the side frame 221 is fixed to a rotary shaft of one adjustment motor 212A fixed to an outer side of the side frame 221. An end portion of the adjustment screw 208B outside the side frame 222 is fixed to a rotary shaft of the other adjustment motor 212B fixed to an outer side of the side frame 222. Therefore, by driving the adjustment motor 212A and the adjustment motor 212B, the adjustment screws 208A and 208B are rotated. The rotation of the adjustment screws 208A and 208B causes the mobile bodies 205 to be displaced in the direction indicated by arrow D1, which is an axial direction of the support shaft 201, due to elastic force of the spring 207 or against this elastic force.

When the mobile body 205 is displaced in the direction indicated by arrow D1, a contact position of the upper end of the contact pin 203 on the inclined surface 205A of the mobile body 205 changes in the direction indicated by arrow D1 and in the direction indicated by arrow H1. When the contact position of the upper end of the contact pin 203 on the inclined surface 205A of the mobile body 205 changes in the direction indicated by arrow H1, the exposure device 40 biased upward by the spring 206 is displaced in the direction indicated by arrow H1 due to elastic force of the spring 206 or against this elastic force.

In this way, when the exposure device 40 is changed in the direction indicated by arrow H1 by driving the adjustment motor 212A and the adjustment motor 212B and thereby rotating the adjustment screws 208A and 208B, the distance between the exposure device 40 and the photoconductor drum 32 may be adjusted. The adjusting device 80 have similar configurations at both end portions of the exposure device 40 in the longitudinal direction (D direction). Therefore, the distance between the exposure device 40 and the photoconductor drum 32 may be individually adjusted at both ends of the exposure device 40 in the longitudinal direction. The adjusting device 80 adjusts a fluctuation in focal position on the photoconductor drum 32 caused by the exposure device 40 by adjusting the distance between the exposure device 40 and the photoconductor drum 32.

### Plural Temperature Sensors 82

As illustrated in FIG. 3, for example, the temperature sensors 82A, 82B, 82C, and 82D are provided beside one end portion of the photoconductor drum 32 in the axial direction (on the right of the photoconductor drum 32 illustrated in FIG. 3 in the axial direction). The temperature sensors 82A, 82B, 82C, and 82D are an example of a temperature detector. The temperature sensors 82A, 82B, 82C, and 82D are provided on any two or more (four in the first exemplary embodiment) among the exposure device 40, the adjusting device 80, and components other than the adjusting device 80 that are interposed between the exposure device 40 and the photoconductor drum 32. Note that in the first exemplary embodiment, in a case where the temperature sensors 82A, 82B, 82C, and 82D need not be distinguished from one another, the reference signs A to D are omitted, and the temperature sensors 82A, 82B, 82C, and 82D are referred to as temperature sensors 82.

For example, the temperature sensor 82A is provided on an end portion of the exposure device 40 in the longitudinal direction. The temperature sensor 82A detects a temperature of the exposure device 40. For example, the temperature sensor 82A is provided on an inner side or an outer side of the housing 50 of the exposure device 40.

The temperature sensor 82B is provided on a constituent member of the adjusting device 80. The temperature sensor 82B detects a temperature of the adjusting device 80. The temperature sensor 82B may be provided on any portion of the constituent member of the adjusting device 80, but is preferably provided on a portion relatively close to the photoconductor drum 32.

The temperature sensor 82C is provided on a holder 90 that holds a shaft portion 32A at an end portion of the photoconductor drum 32 in the axial direction. The holder 90 rotatably holds the photoconductor drum 32. The temperature sensor 82C detects a temperature of the holder 90. The holder 90 is an example of a component other than the adjusting device 80 interposed between the exposure device 40 and the photoconductor drum 32. The holder 90 is an example of a holder.

The temperature sensor 82D is provided on a frame 92 that supports the adjusting device 80. In the first exemplary embodiment, the frame 92 also supports the holder 90. The temperature sensor 82D detects a temperature of the frame 92. The frame 92 is an example of a component other than the adjusting device 80 interposed between the exposure device 40 and the photoconductor drum 32. The frame 92 is an example of a supporter.

Similarly, the temperature sensors 82A, 82B, 82C, and 82D are provided beside the other end portion of the photoconductor drum 32 in the axial direction (on the left of the photoconductor drum 32 in the axial direction) although illustration thereof is omitted. The temperature sensors 82A, 82B, 82C, and 82D are provided on components (i.e., the exposure device 40, the adjusting device 80, the holder 90, and the frame 92) similar to those beside the one end portion of the photoconductor drum 32 in the axial direction. For example, the temperature sensors 82A, 82B, 82C, and 82D are provided at positions similar to those on the components beside the one end portion of the photoconductor drum 32 in the axial direction.

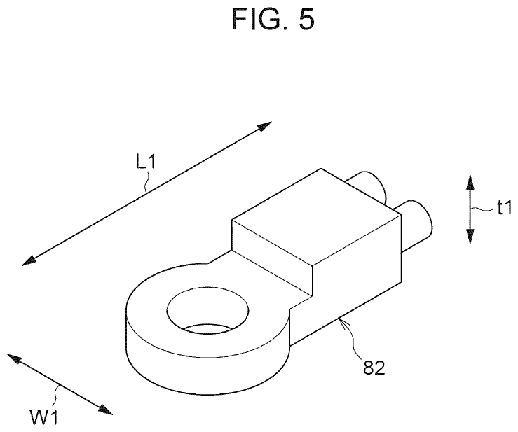

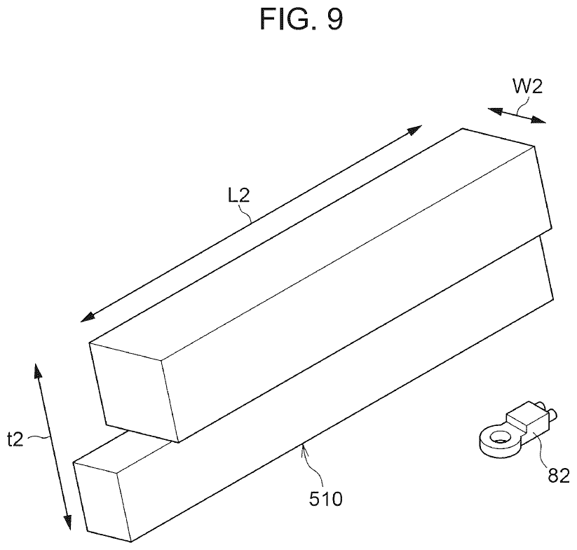

As illustrated in FIG. 5, a thermocouple is used as each of the temperature sensors 82. A dimension of each of the temperature sensors 82 is, for example, smaller than a dimension of a typical distance sensor that measures a distance between a photoconductor drum and an exposure device (see FIG. 9). The dimension of each of the temperature sensors 82 is set so that a maximum value of a length in a direction indicated by arrow L1 is 11 mm, a maximum value of a width in a direction indicated by arrow W1 is 7 mm, and a maximum value of a thickness in a direction indicated by arrow t1 is 3 mm.

### Control Device 110

Next, the control device 110 of the image formation system 10 is described.

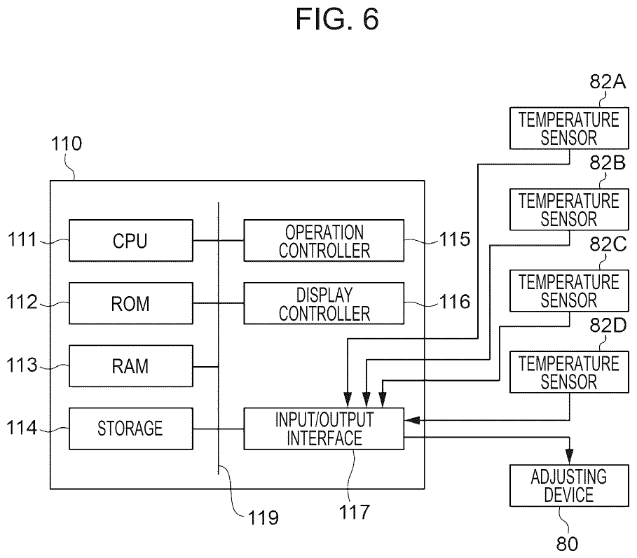

FIG. 6 is a block diagram illustrating a hardware configuration of the image formation system 10. As illustrated in FIG. 6, the control device 110 includes a central processing unit (CPU) 111, a read only memory (ROM) 112, a random access memory (RAM) 113, a storage 114, an operation controller 115, a display controller 116, and an input/output interface 117. These constituent elements are communicably connected to one another by a bus 119. Note that the control device 110 may include a communication interface or the like for communication of information with an external device in addition to the above constituent elements.

The CPU 111 is a central processing unit, and executes various programs and controls each unit. The CPU 111 is an example of a processor. The CPU 111 reads out a program from the ROM 112 or the storage 114 and executes the program while using the RAM 113 as a work area. In the present embodiment, a processing program is stored in the ROM 112 or the storage 114. The CPU 111 controls the above constituent elements and performs various kinds of arithmetic processing in accordance with the processing program recorded on the ROM 112 or the storage 114.

The ROM 112 stores therein various programs and various data. The RAM 113 temporarily stores therein a program or data as a work area. The storage 114 is a hard disk drive (HDD) or a solid state drive (SSD), and stores therein various programs including an operating system and various data.

The operation controller 115 controls input operation and the like of an operation unit (not illustrated). For example, an operation instruction for the image formation system 10 is input from the operation unit. The CPU 111 causes each unit of the image formation system 10 to operate on the basis of the operation instruction from the operation unit.

The display controller 116 controls a screen displayed on a display unit (not illustrated). Note that the operation unit and the display unit may be an integral liquid crystal display.

The input/output interface 117 is an interface for transmitting and receiving information to and from a peripheral device of the control device 110. For example, the input/output interface 117 is connected to the temperature sensors 82A, 82B, 82C, and 82D and the adjusting device 80. Instead of this configuration, the temperature sensors 82A, 82B, 82C, and 82D and the adjusting device 80 may be directly connected by the bus 119. Temperatures detected by the temperature sensors 82A, 82B, 82C, and 82D are input to the CPU 111 via the input/output interface 117. The CPU 111 controls the adjustment motor 212A and the adjustment motor 212B by outputting a signal to the adjusting device 80 via the input/output interface 117.

The CPU 111 predicts a fluctuation amount of the distance between the photoconductor drum 32 and the exposure device 40 (in the first exemplary embodiment, a fluctuation of a focal position on the photoconductor drum 32 caused by the exposure device 40) on the basis of the temperatures detected by the temperature sensors 82A, 82B, 82C, and 82D. Then, the CPU 111 adjusts the fluctuation amount of the distance between the photoconductor drum 32 and the exposure device 40 (in the first exemplary embodiment, the fluctuation of the focal position on the photoconductor drum 32 caused by the exposure device 40) by the adjusting device 80. The adjusting the fluctuation of the focal position means adjusting the distance between the photoconductor drum 32 and the exposure device 40 so that displacement of a focal point is reduced.

In the first exemplary embodiment, the temperature sensors 82A, 82B, 82C, and 82D are provided at both end portions of the exposure device 40 and the photoconductor drum 32 in the axial direction. Furthermore, the adjusting device 80 includes the adjustment motor 212A and the adjustment motor 212B beside one end portion and the other end portion of each of the exposure device 40 and the photoconductor drum 32 in the axial direction (scc FIG. 4), respectively. The adjusting device 80 independently adjusts the distance between the photoconductor drum 32 and the exposure device 40 at both end portions of the exposure device 40 and the photoconductor drum 32 in the axial direction by the adjustment motor 212A and the adjustment motor 212B. The independently adjusting the distance means individually adjusting the distance between the photoconductor drum 32 and the exposure device 40 at both end portions of the photoconductor drum 32 in the axial direction.

As illustrated in FIG. 3, the temperature sensor 82A detects a temperature of the exposure device 40 beside the one end portion of the photoconductor drum 32 in the axial direction. The temperature sensor 82B detects a temperature of the adjusting device 80 beside the one end portion of the photoconductor drum 32 in the axial direction. The temperature sensor 82C detects a temperature of the holder 90 beside the one end portion of the photoconductor drum 32 in the axial direction. The temperature sensor 82D detects a temperature of the frame 92 beside the one end portion of the photoconductor drum 32 in the axial direction. The CPU 111 calculates a temperature change amount of the holder 90, a temperature change amount of the frame 92, a temperature change amount of the exposure device 40, and a temperature change amount of the adjusting device 80 from a predetermined reference temperature.

For example, the adjustment amount of the distance between the photoconductor drum 32 and the exposure device 40 is calculated by the following method. Here, ad is a thermal expansion coefficient [mm/° C.] of the holder 90, and Td is a temperature change amount [° C.] of the holder 90. In this case, a change amount Ld [mm] of the distance caused by a temperature change of the holder 90 is calculated by the following formula:

$$Ld = Td \times a d$$

Similarly, af is a thermal expansion coefficient [mm/° C.] of the frame 92, and Tf is a temperature change amount [° C.] of the frame 92. In this case, a change amount Lf [mm] of the distance caused by a temperature change of the frame 92 is calculated by the following formula:

$$Lf = Tf \times a f$$

Note that a change amount of the distance caused by a temperature change of the exposure device 40 and a change amount of the distance caused by a temperature change of the adjusting device 80 are also calculated by a similar method although description thereof is omitted.

In this case, an adjustment amount L of the distance between the photoconductor drum 32 and the exposure device 40 is calculated by the following formula:

$$L = L f + L d + …$$

The CPU 111 adjusts the distance between the photoconductor drum 32 and the exposure device 40 beside the one end portion of the photoconductor drum 32 in the axial direction by driving the adjusting device 80 in accordance with the adjustment amount L of the distance between the photoconductor drum 32 and the exposure device 40.

Similarly, the CPU 111 calculates an adjustment amount L of the distance between the photoconductor drum 32 and the exposure device 40 on the basis of temperatures detected by the temperature sensors 82A, 82B, 82C, and 82D provided beside the other end portion of the photoconductor drum 32 in the axial direction. The CPU 111 adjusts the distance between the photoconductor drum 32 and the exposure device 40 beside the other end portion of the photoconductor drum 32 in the axial direction by driving the adjusting device 80 in accordance with the adjustment amount L of the distance between the photoconductor drum 32 and the exposure device 40.

### Image Formation System of Comparative Example

An image formation system of a comparative example is described below.

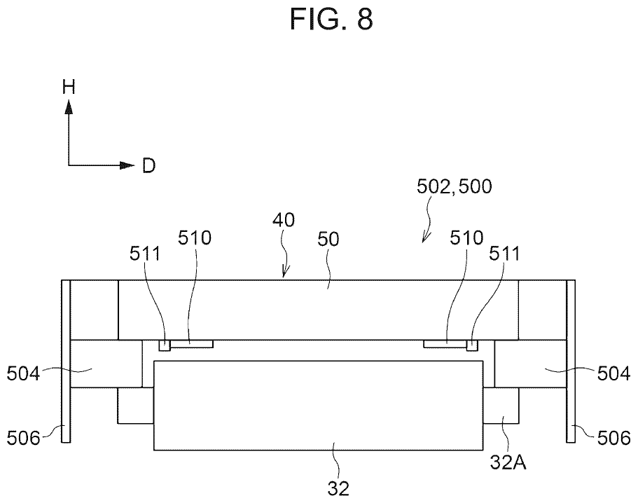

FIG. 8 illustrates a part of a toner image forming unit 502 of an image formation system 500 of the comparative example. As illustrated in FIG. 8, the image formation system 500 includes a photoconductor drum 32, an exposure device 40, an adjusting device 504, and a frame 506. The adjusting device 504 adjusts a distance between the photoconductor drum 32 and the exposure device 40. The frame 506 supports the adjusting device 504. Furthermore, the image formation system 500 includes a distance sensor 510 on both end portions of the exposure device 50 in a longitudinal direction. The distance sensor 510 measures a distance between the photoconductor drum 32 and the exposure device 40. The distance sensor 510 is, for example, fixed on a surface of a housing 50 of the exposure device 40 that faces the photoconductor drum 32 by using an attachment unit 511.

In the image formation system 500, the adjusting device 504 adjusts the distance between the photoconductor drum 32 and the exposure device 40 on the basis of a change amount of the distance between the photoconductor drum 32 and the exposure device 40 measured by the distance sensor 510.

The distance sensor 510 is, for example, a magnetic displacement sensor. As illustrated in FIG. 9, a dimension of the distance sensor 510 is larger than the dimension of each of the temperature sensors 82 used in the image formation system 10 of the first exemplary embodiment. The dimension of the distance sensor 510 is, for example, set so that a maximum value of a length in a direction indicated by arrow L2 is 94 mm, a maximum value of a width in a direction indicated by arrow W2 is 17 mm, and a maximum value of a thickness in a direction indicated by arrow t2 is 27 mm. Furthermore, the distance sensor 510 is more expensive than the temperature sensor 82. That is, cost of the image formation system 500 is high because of the expensive distance sensor 510. Furthermore, a device size of the image formation system 500 is large since the distance sensor 510 is large in size.

### Second Exemplary Embodiment

Next, an image formation system according to a second exemplary embodiment is described. Note that constituent parts identical to those in the first exemplary embodiment are given identical reference signs, and description thereof is omitted.

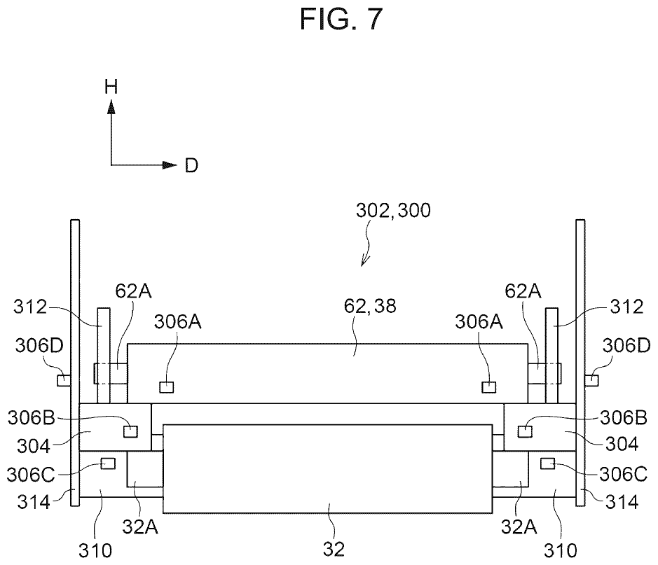

FIG. 7 illustrates a part of a toner image forming unit 302 of an image formation system 300 according to the second exemplary embodiment. As illustrated in FIG. 7, the image formation system 300 includes a photoconductor drum 32, a developing device 38 including a development roller 62, and an adjusting device 304. The development roller 62 is opposed to the photoconductor drum 32. The development roller 62 is an example of an opposed member and an example of a developing unit. The development roller 62 develops an electrostatic latent image formed on the photoconductor drum 32 by attachment of toner.

The adjusting device 304 adjusts a distance between the development roller 62 and the photoconductor drum 32. The adjusting device 304 is an example of an adjuster. The development roller 62 is connected to the photoconductor drum 32 by the adjusting device 304 that adjusts the distance to the photoconductor drum 32. The adjusting device 304 adjusts the distance between the development roller 62 and the photoconductor drum 32 by moving a frame body 312 that rotatably supports a shaft portion 62A of the development roller 62. A configuration of the adjusting device 304 may be, for example, similar to that of the adjusting device 80 although illustration thereof is omitted.

The image formation system 300 includes plural temperature sensors 306 (e.g., temperature sensors 306A, 306B, 306C, and 306D). The temperature sensors 306 are an example of a temperature detector. The temperature sensors 306 are provided on any two or more components among the development roller 62, the adjusting device 304, and components other than the adjusting device 304 that are interposed between the development roller 62 and the photoconductor drum 32.

For example, the temperature sensor 306A is provided on both end portions of the development roller 62 in an axial direction. The temperature sensor 306A detects a temperature of the development roller 62.

The temperature sensor 306B is provided on a constituent member of the adjusting device 304 at both end portions of the photoconductor drum 32 in an axial direction. The temperature sensor 306B detects a temperature of the adjusting device 304.

The temperature sensor 306C is provided on a holder 310 that holds a shaft portion 32A at both end portions of the photoconductor drum 32 in the axial direction. The temperature sensor 306C detects a temperature of the holder 310. The holder 310 is an example of a component other than the adjusting device 304 interposed between the development roller 62 and the photoconductor drum 32. The holder 310 is an example of a holder.

The temperature sensor 306D is provided on a frame 314 that supports the adjusting device 304. In the second exemplary embodiment, the frame 314 also supports the holder 310. The temperature sensor 306D detects a temperature of the frame 314. The frame 314 is an example of a component other than the adjusting device 304 interposed between the development roller 62 and the photoconductor drum 32. The frame 314 is an example of a supporter.

A CPU of a control device (not illustrated) predicts a fluctuation amount of the distance between the photoconductor drum 32 and the development roller 62 on the basis of the temperatures detected by the temperature sensors 306A, 306B, 306C, and 306D. Then, the CPU adjusts the fluctuation amount of the distance between the photoconductor drum 32 and the development roller 62 by the adjusting device 304.

The temperature sensors 306A, 306B, 306C, and 306D are provided beside both end portions of the photoconductor drum 32 in the axial direction. The adjusting device 304 independently adjusts the distance between the photoconductor drum 32 and the development roller 62 at both end portions of the photoconductor drum 32 and the development roller 62 in the axial direction. Note that other configurations of the image formation system 300 are similar to those of the image formation system 10 of the first exemplary embodiment.

The image formation system 300 of the second exemplary embodiment has the following effects in addition to the effects produced by the configuration similar to the image formation system 10 of the first exemplary embodiment.

In the image formation system 300 of the second exemplary embodiment, the development roller 62 that develops an electrostatic latent image formed on the photoconductor drum 32 by attachment of toner is provided at a position opposed to the photoconductor drum 32. In the image formation system 300, the fluctuation amount of the distance between the photoconductor drum 32 and the development roller 62 is adjusted by the adjusting device 304 on the basis of the temperatures detected by the temperature sensors 306A, 306B, 306C, and 306D. Accordingly, an increase in cost of the image formation system 300 may be kept small as compared with a case where a distance sensor that measures a distance between a photoconductor drum and a development roller is attached to the development roller.

### Supplemental Remarks

The image formation system of the present disclosure is not limited to the image formation systems 10 and 300 described in the first and second exemplary embodiments and can be changed in various ways. For example, the configurations of the adjusting device 80 and the adjusting device 304 may be changed. The number of temperature sensors may be changed to other numbers equal to or larger than 2, and positions at which the temperature sensors are attached may also be changed to other two or more positions.

Although the adjusting device 80 independently adjusts the distance between the photoconductor drum 32 and the exposure device 40 at both end portions of the photoconductor drum 32 in the axial direction in the image formation system 10 described in the first exemplary embodiment, the present disclosure is not limited to this configuration. For example, it is also possible to employ a configuration in which the distance between the photoconductor drum 32 and the exposure device 40 is adjusted by one adjusting device. Although the adjusting device 304 independently adjusts the distance between the photoconductor drum 32 and the development roller 62 at both end portions of the photoconductor drum 32 in the axial direction in the image formation system 300 described in the second exemplary embodiment, the present disclosure is not limited to this configuration. For example, it is also possible to employ a configuration in which the distance between the photoconductor drum 32 and the development roller 62 is adjusted by one adjusting device.

Although the adjusting device and the temperature sensors are provided at both end portions of the photoconductor drum 32 in the axial direction in the first and second exemplary embodiments, the present disclosure is not limited to this configuration. For example, the adjusting device and the temperature sensors may be provided at one end portion of the photoconductor drum 32 in the axial direction.

Although components on which the temperature sensors are provided at one end portion of the photoconductor drum 32 in the axial direction and components on which the temperature sensors are provided at the other end portion of the photoconductor drum 32 in the axial direction are identical in the first and second exemplary embodiment, the present disclosure is not limited to this configuration. For example, components on which the temperature sensors are provided at one end portion of the photoconductor drum 32 in the axial direction and components on which the temperature sensors are provided at the other end portion of the photoconductor drum 32 in the axial direction may be different.

The above processing of the image formation systems 10 and 300 may be realized by a dedicated hardware circuit. In this case, the processing may be performed by one piece of hardware or may be performed by plural pieces of hardware.

A program for causing the image formation systems 10 and 300 to operate may be offered by a computer-readable recording medium such as a universal serial bus (USB) memory, a flexible disc, or a compact disc read only memory (CD-ROM) or may be offered on-line over a network such as the Internet. In this case, the program recorded on the computer-readable recording medium is typically transferred to and stored in a memory, a storage, or the like. This program may be, for example, offered as independent application software or may be, for example, incorporated as one function of the image formation system 10 or 300 into software of each device thereof.

Note that although specific exemplary embodiments of the present disclosure have been described in detail, the present disclosure is not limited to these exemplary embodiments, and it is clear to a person skilled in the art that other various exemplary embodiments are conceivable within the scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image formation system including:
an image carrier that rotates;
an opposed member that is opposed to the image carrier and is connected to the image carrier by an adjuster that adjusts a distance to the image carrier; and
a temperature detector that is provided on any two or more components among the opposed member, the adjuster, and components other than the adjustor that are interposed between the opposed member and the image carrier.
   (((2)))

The image formation system according to (((1))), further including a processor configured to adjust a fluctuation amount of the distance between the image carrier and the opposed member by the adjuster on the basis of a temperature detected by the temperature detector.

(((3)))

The image formation system according to (((1))) or (((2)), in which
the opposed member is an exposure unit including:
a lens group including plural lenses that extend in an axial direction of the image carrier and allow light to which the image carrier is to be exposed to pass therethrough, and
a substrate on which plural light-emitting elements that emit the light is mounted.
   (((4)))

The image formation system according to (((3))), in which the adjustor adjusts a fluctuation of a focal position on the image carrier caused by the exposure unit.

(((5)))

The image formation system according to any one of (((1))) to (((4))), in which the opposed member is a developing unit that develops an electrostatic latent image formed on the image carrier by attachment of toner.

(((6)))

The image formation system according to (((2))), in which
the components other than the adjustor that are interposed between the opposed member and the image carrier include a holder that holds an end portion of the image carrier in an axial direction, and
the temperature detector is provided on the holder.
   (((7)))

The image formation system according to (((2))), in which
the components other than the adjustor that are interposed between the opposed member and the image carrier include a supporter that supports the adjustor, and
the temperature detector is provided on the supporter.
   (((8)))

The image formation system according to any one of (((1))) to (((7))), in which
the temperature detector is a thermocouple.
   (((9)))

The image formation system according to any one of (((1))) to (((8))), in which
the adjustor and the temperature detector are provided at both end portions of the opposed member and the image carrier in an axial direction.
   (((10)))

The image formation system according to (((9))), in which
components on which the temperature detector is provided at one end portion of the opposed member and the image carrier in the axial direction and components on which the temperature detector is provided at the other end portion of the opposed member and the image carrier in the axial direction are identical.
   (((11)))

The image formation system according to (((9))), in which
the adjustor independently adjusts the distance between the image carrier and the opposed member at both end portions of the opposed member and the image carrier in the axial direction.

What is claimed is:

1. An image formation system comprising:
an image carrier that rotates;
an opposed member that is opposed to the image carrier and is connected to the image carrier by an adjuster that adjusts a distance to the image carrier; and
a temperature detector that is provided on any two or more components among the opposed member, the adjuster, and components other than the adjustor that are interposed between the opposed member and the image carrier.

2. The image formation system according to claim 1, further comprising a processor configured to adjust a fluctuation amount of the distance between the image carrier and the opposed member by the adjuster on a basis of a temperature detected by the temperature detector.

3. The image formation system according to claim 1, wherein:
the opposed member is an exposure unit including:
a lens group including a plurality of lenses that extend in an axial direction of the image carrier and allow light to which the image carrier is to be exposed to pass therethrough; and
a substrate on which a plurality of light-emitting elements that emit the light is mounted.

4. The image formation system according to claim 3, wherein:
the adjustor adjusts a fluctuation of a focal position on the image carrier caused by the exposure unit.

5. The image formation system according to claim 1, wherein:
the opposed member is a developing unit that develops an electrostatic latent image formed on the image carrier by attachment of toner.

6. The image formation system according to claim 2, wherein:
the components other than the adjustor that are interposed between the opposed member and the image carrier include a holder that holds an end portion of the image carrier in an axial direction, and
the temperature detector is provided on the holder.

7. The image formation system according to claim 2, wherein:
the components other than the adjustor that are interposed between the opposed member and the image carrier include a supporter that supports the adjustor, and
the temperature detector is provided on the supporter.

8. The image formation system according to claim 1, wherein:
the temperature detector is a thermocouple.

9. The image formation system according to claim 1, wherein:
the adjustor and the temperature detector are provided at both end portions of the opposed member and the image carrier in an axial direction.

10. The image formation system according to claim 9, wherein:
components on which the temperature detector is provided at one end portion of the opposed member and the image carrier in the axial direction and components on which the temperature detector is provided at an other end portion of the opposed member and the image carrier in the axial direction are identical.

11. The image formation system according to claim 9, wherein:
the adjustor independently adjusts the distance between the image carrier and the opposed member at both end portions of the opposed member and the image carrier in the axial direction.
